(19) United States
(12) Patent Application Publication
(10) Pub. No.: US 2025/0029453 A1
(43) Pub. Date: Jan. 23, 2025

(54) APPARATUS, SYSTEM AND METHOD FOR A HYBRID MOBILE APPLICATION FOR TRACKING REAL-TIME GAME SHOW SCORES

(71) Applicant: A Really Big Corporation, Inc., Newburgh, NY (US)

(72) Inventor: Will CAPPELLETTI, Newburgh, NY (US)

(73) Assignee: A Really Big Corporation, Inc., Newburgh, NY (US)

(21) Appl. No.: 18/223,216

(22) Filed: Jul. 18, 2023

(51) Int. Cl. G07F 17/32

(52) U.S. Cl. CPC G07F 17/3276; G07F 17/3213; G07F 17/3239; G07F 17/3288

(57) ABSTRACT

An apparatus, system and method for hybrid mobile application for tracking real-time game show scores.

### BACKGROUND OF THE INVENTION

### 1. The Field of the Present Invention

The present invention is generally related to a system, method and apparatus for a hybrid mobile application for tracking real-time game show scores. More specifically, a mobile device application to track game show scores in real time with others.

### 2. General Background

The purpose of this mobile application is to be able to play game show games, such as Jeopardy®, and keep track of their score while in real time. An additional purpose of this invention is to provide a mobile application be able to play game show games for prior played and recorded games.

What is needed is simple system, method and apparatus for simultaneous playing of television or online game shows.

### SUMMARY OF THE INVENTION

We have discovered an apparatus, system and method for a hybrid mobile application for tracking real-time game show scores.

In a first aspect the present invention includes a method of playing a game on a web-connected mobile device based on content having a player receiving content and one or more game data files, wherein the content is simultaneously viewed by the player as the player plays the game via the internet on the web-connected mobile device, an operating a program on the web-connected mobile device to display one or more dynamic game play screens in phased consistency relative to the simultaneously viewed content and the player playing the game by selecting one or more choices related to dynamic game play screens in phased consistency relative to the simultaneously viewed content.

Some embodiments include repeating providing at least two game options to the player tracking the player's gameplay and recording said gameplay in a remote database.

Some embodiments include gameplay being compared to additional players playing the game and where a player is allowed to make a wager before playing the game.

In some embodiments a player is required to make a wager while playing the game.

In some embodiments content is based on at least one previously recorded and stored television game show where the content is based on at least one television game show being broadcast simultaneously with the player playing the game.

In some embodiments game data is updated in real time as the player is playing the game.

In a second aspect the present invention includes a system for producing and distributing a game on a web connected mobile device based on content including a game production device for connecting the content with live game data and a first server coupled to the game production device, wherein the server receives and transmits the content and the live game data, wherein the game is played by at least one player selecting one or more choices related to the content.

In some embodiments the system includes second server coupled to the first server for receiving scoring data, determining standings and communicating the standings to the at least one player.

In some embodiments the system includes a game that is played based on content that is selected as one of simultaneously live on-demand and practice. The on-demand video and game data can be simultaneously broadcast to all players at a pre-determined time.

In some embodiments the system includes content such as sporting events, game shows, news programming and entertainment shows.

In some embodiments the system includes a third server coupled to the first and second server, the third server structured and arranged to mange the at least one player's wagers made before and during the game.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows a process flow diagram of the mobile software application according to one embodiment of the present invention; and

FIGS. 2-45 show exemplary screen shots from the mobile software application according to one embodiment of the present invention.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

The layout will be a box at the top center of the screen which displays the total score of the player and is determined by 10 buttons which are 5 buttons on the left indicating scores of −200, −400, −600, −800, and −1000 which selected by the player may affect the total score shown above by that denomination. These may be pressed when the wrong answer is given for a question of that denomination. There may also be multiple buttons on the right +200, +400, +600, +800, +1000 which can be pressed when the correct answer is given for a question of that denomination.

There can also be an “UNDO” button in case a player hits a button by mistake. There can be a Double Score button which will change the values of the buttons to −400, −800, −1200, −1600, −2000, and +400, +800, +1200, +1600, +2000 respectively.

At the bottom of the screen there may has to be a button for daily doubles in a player may your input a desired score with a plus or minus tag. For the first round it can be either up to 1,000 regardless of the player's score or up to your current score. By way of example if a player has 200 such player may select 0-1000, however but if the player has 5,000 the player may select put 0-5,000. There may also be an option to bet it all (a true daily double). For the Second round a player may be select up to 2,000 regardless of the player's score is or up to your current score. By way of example if the player has 1400 such player may select 0-2000 however is such play has 16,000 the player may select anywhere in the range of 0-16,000.

At the end of every game the player will get a report of how many times players hit each button and what values were put in for the doubles and the players will be able to save it for reference.

A leaderboard may be provided for all players in particular game or a specific date as well as overall historical statistics for all players for all time game.

For monetization there can be an ad feature every time the game is opened and the option to pay a predetermined fee to use the game for a specific time period advertisement free.

For traditional score reporting there can be a master report server for data and research purposes that includes the date of a game played as well as percentage of players that answered each question correct, wrong, or passed. Each Category will be numbered “1” through “12” respectively in the order they appear and each question point amount will be lettered “A” through “E” from 200 to 1,000 and 400 to 2,000. For example, if Category 1, 200-point question is selected that will be in the report as 1A in the report and if in the 2000 point question in the last category is selected it will be in the report as 12E. Final game answers will also be stored in the report server.

For each players traditional reporting can be a screenshot of their game with the questions they answered correctly based on color and scores wagered as well as final score. Each question and the percentage of players that answered correctly can also be displayed.

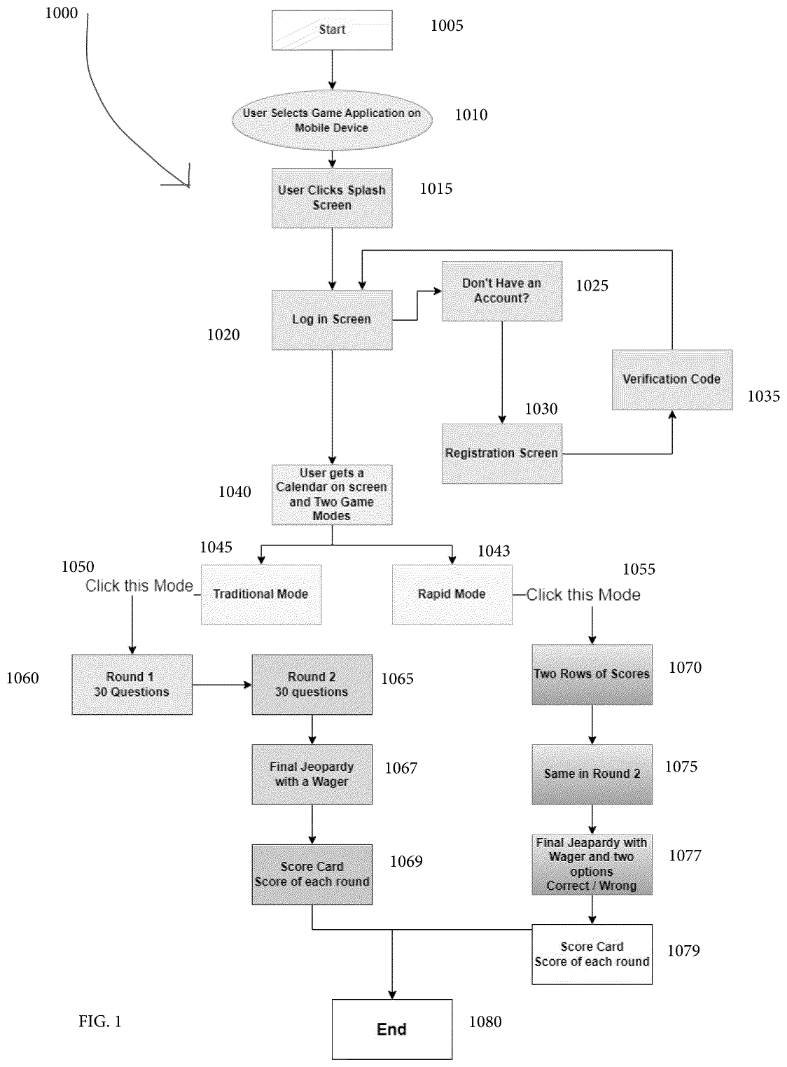

Referring now to FIG. 1, there is shown a flow diagram representing a logic flow for the software application associated with mobile device application in one embodiment of the present invention.

A player starts 1005 the mobile device application 1000 by selecting the application on their mobile device 1010. A splash screen 1015 is displayed for the player to click where the log in screen 1020 will be presented. If the player does not have an account 1025 a registration screen is displayed 1030 and a verification process 1035 begins. Once the player registers and/or logs into the application 1000, a calendar 1040 is displayed for the player to select one of several options for games modes, including but limited to traditional mode 1045 and rapid mode 1043.

If the player clicks traditional mode 1050, round 1 of 30 questions 1060, begins. Once the player completes the timed Round 1, Round 2 of 60 questions 1065 is provided. Once the player completes the timed Round 2, Finally Round 1067 is provided. A wager can be provided at this or any of the rounds. Once the player completes the game a score card for each round 1069 is presented and logged into the player records in a data storage location, which storage can be localized or on a cloud network. In some embodiments the player's records can be stored with the records of other players in a leading charts file which can be tabulated and prized according to preferred tournaments and player-based challenges.

If the player chooses 1055 to play in Rapid Mode 1043 two rows of scores 1070 can be provided. This can be repeated 1075. Once the player completes the first two rapid rounds there can be presented a Final Round 1077. At any point in the game wagers can be made by the player. A score card 1079 for each round can be created and stored either locally or in a cloud-based environment. Once the player completes the game the application can end 1080.

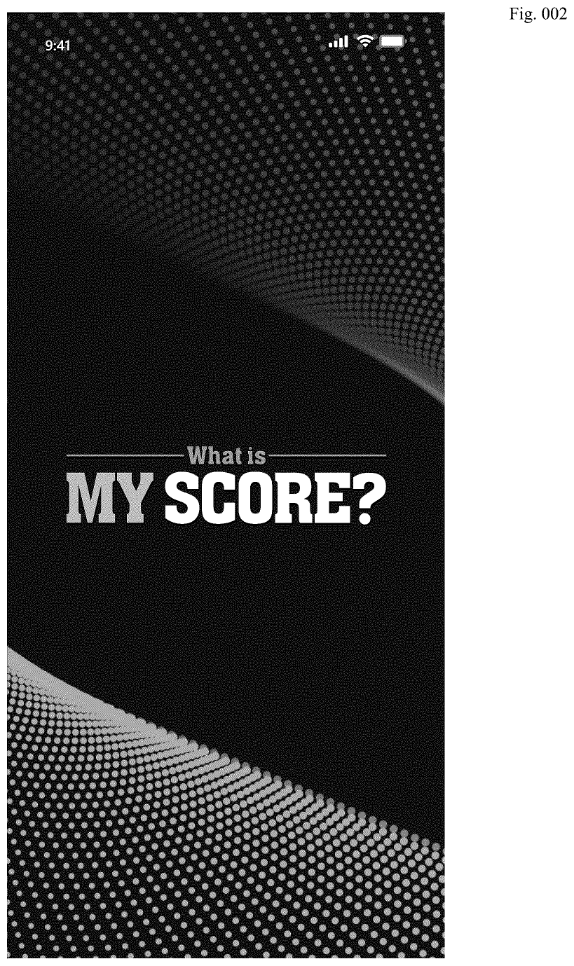

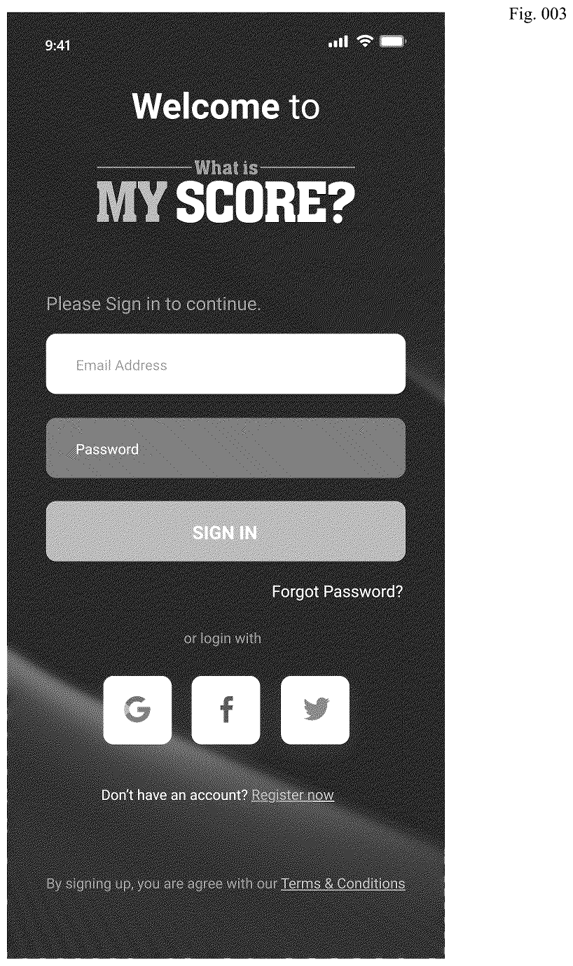

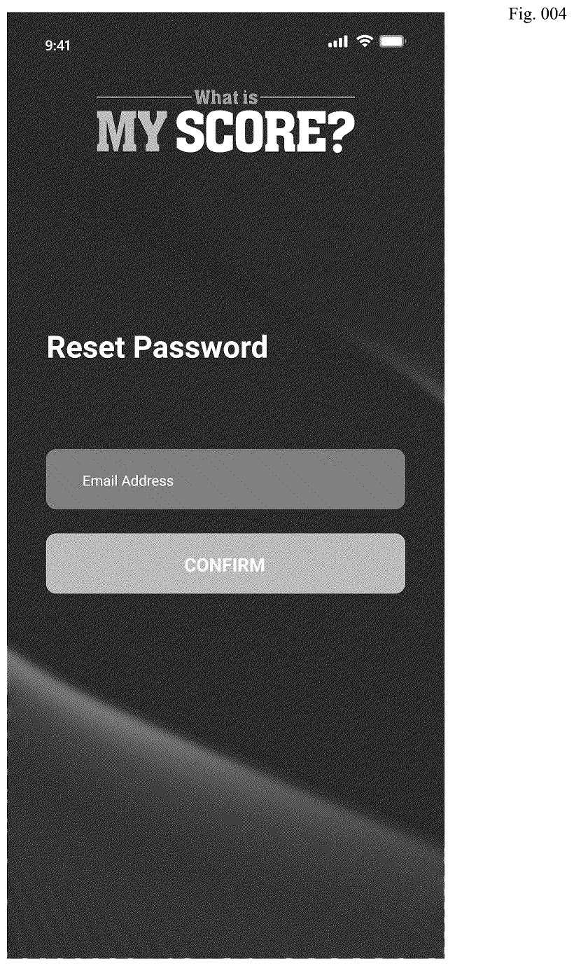

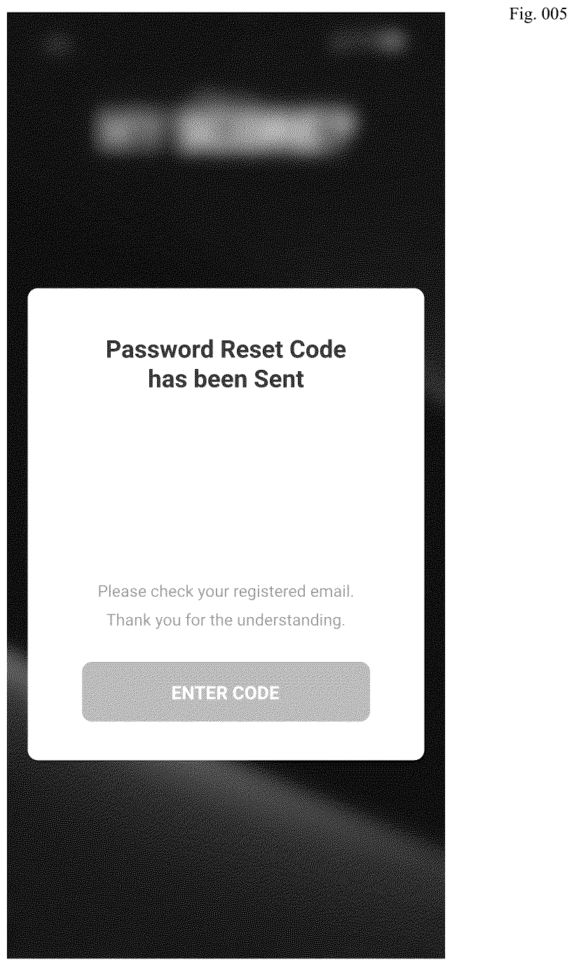

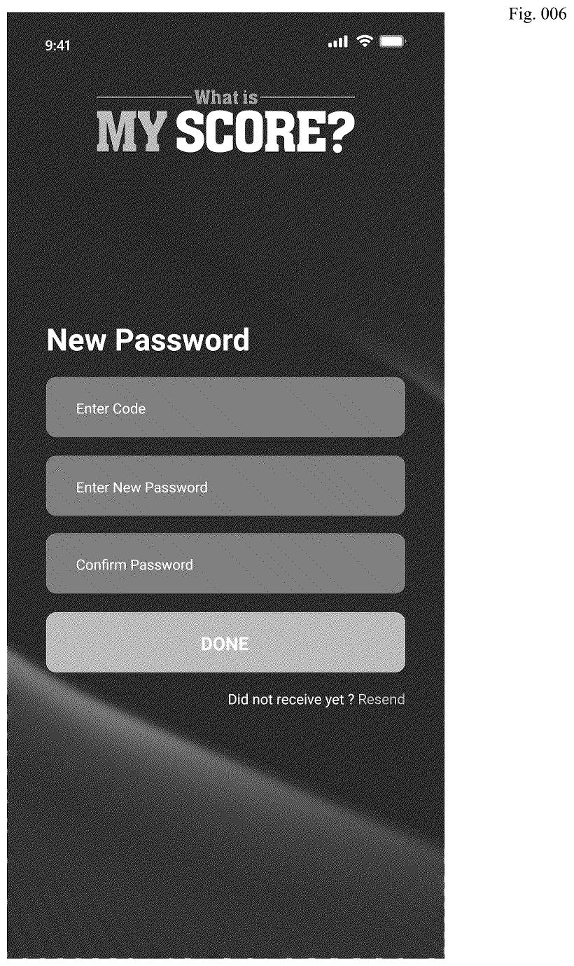

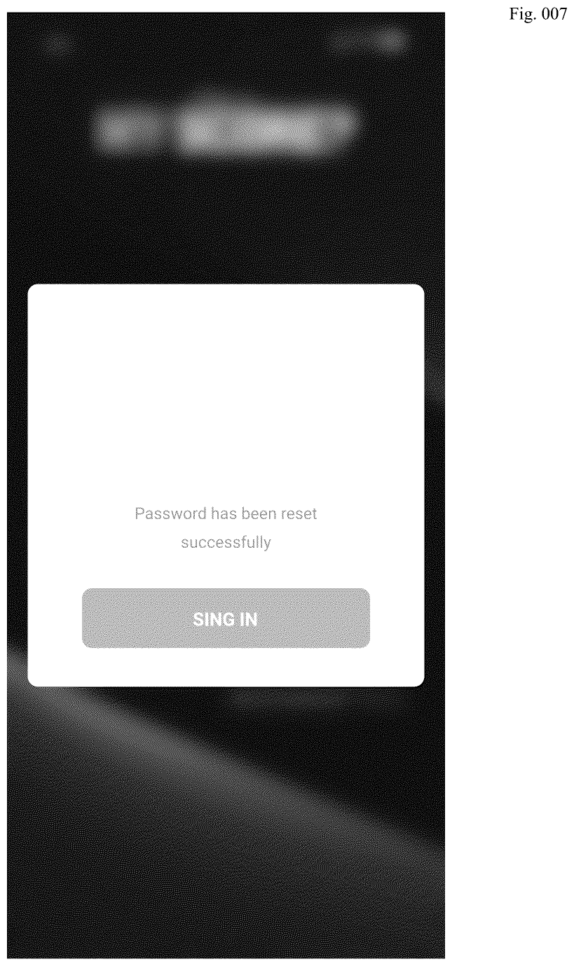

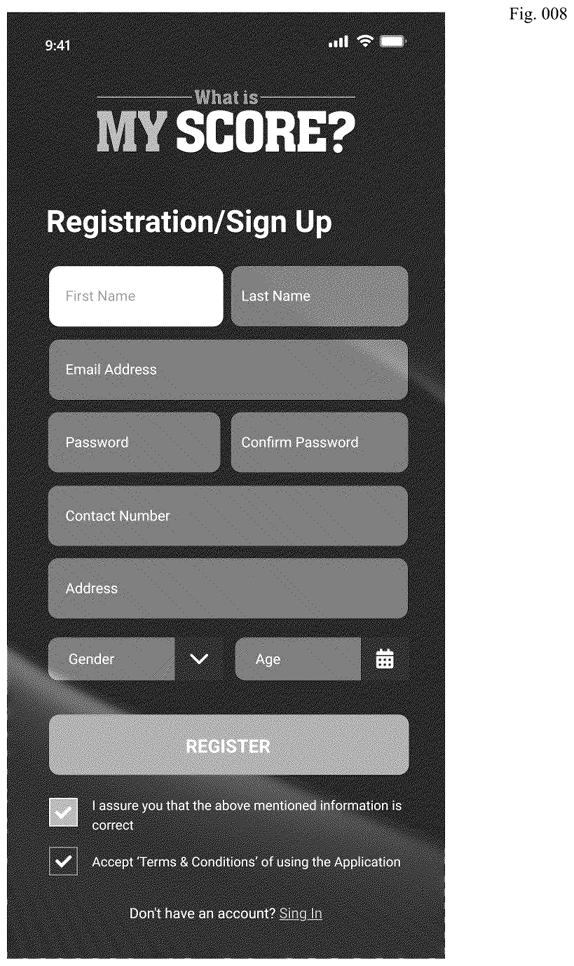

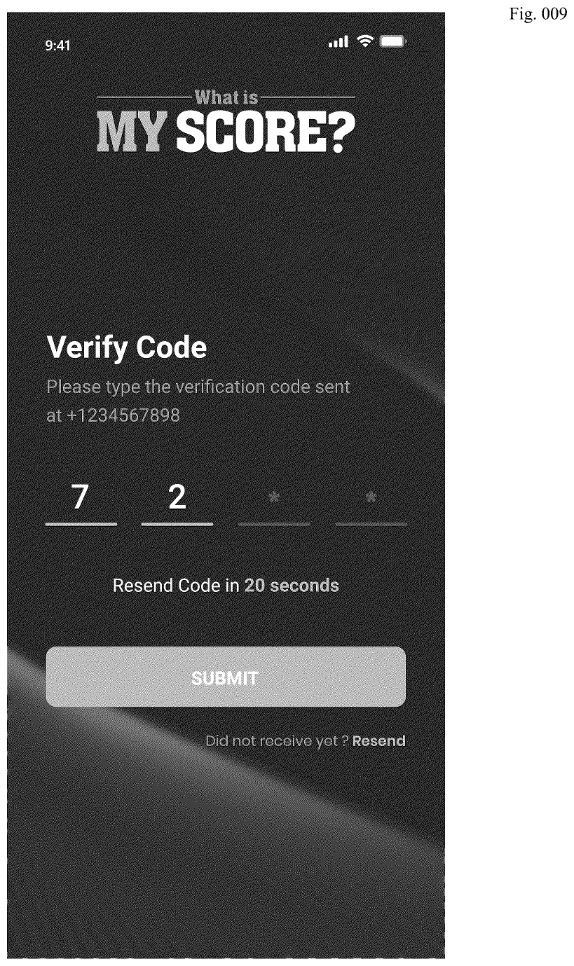

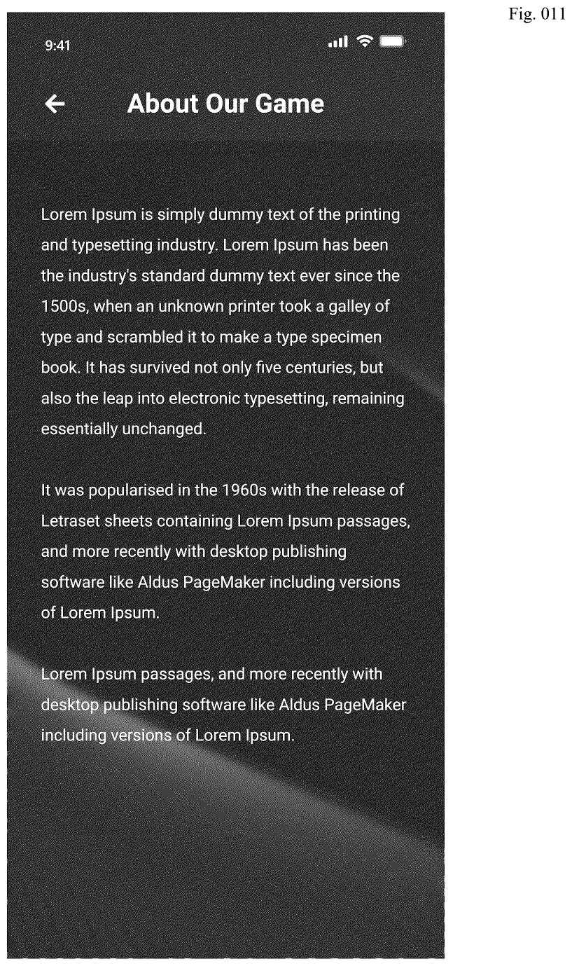

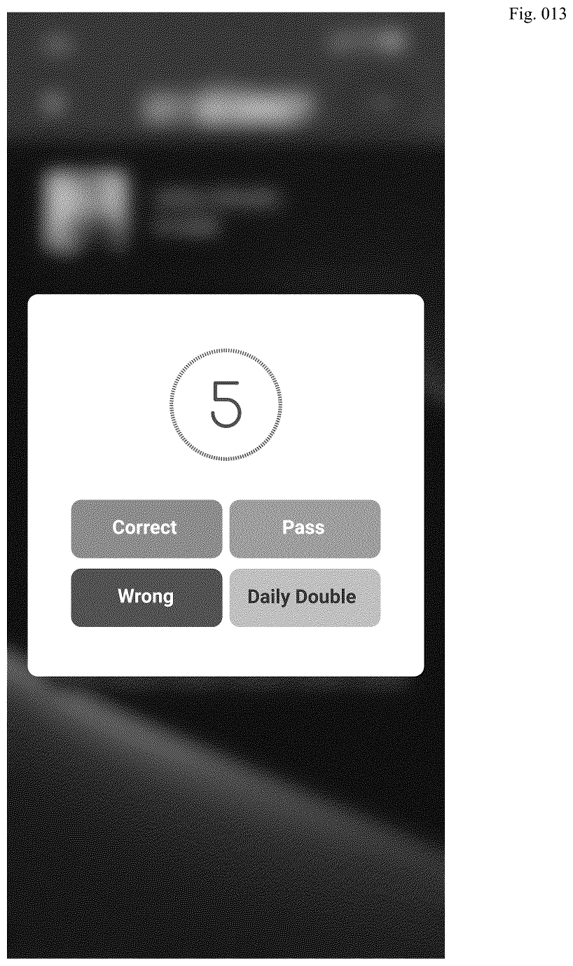

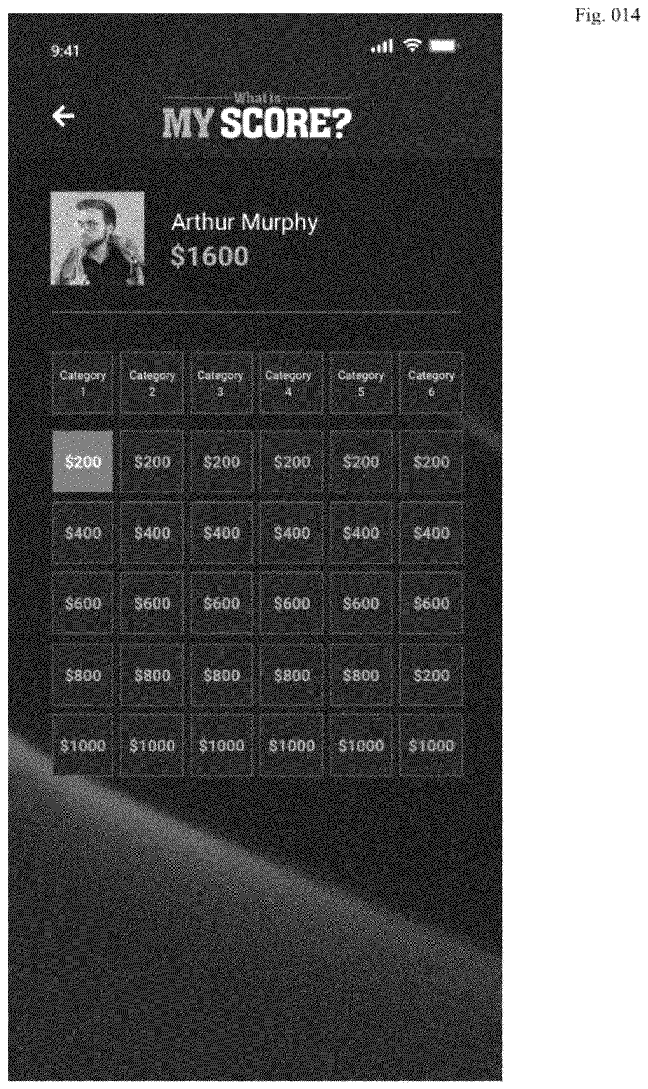

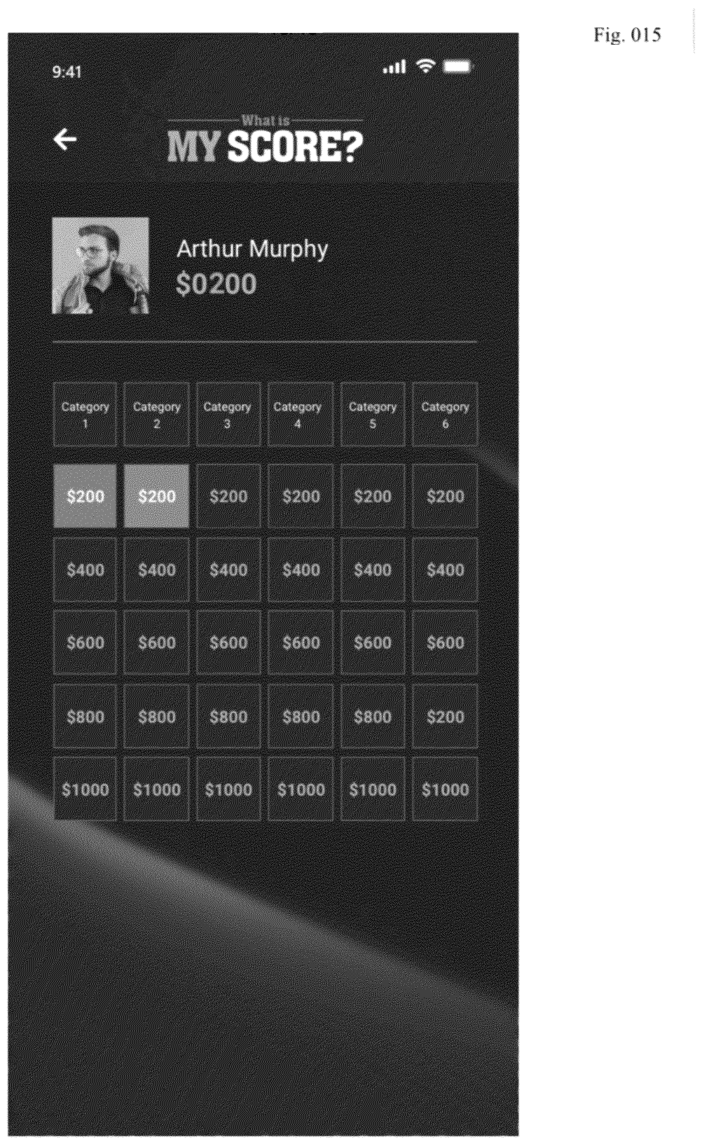

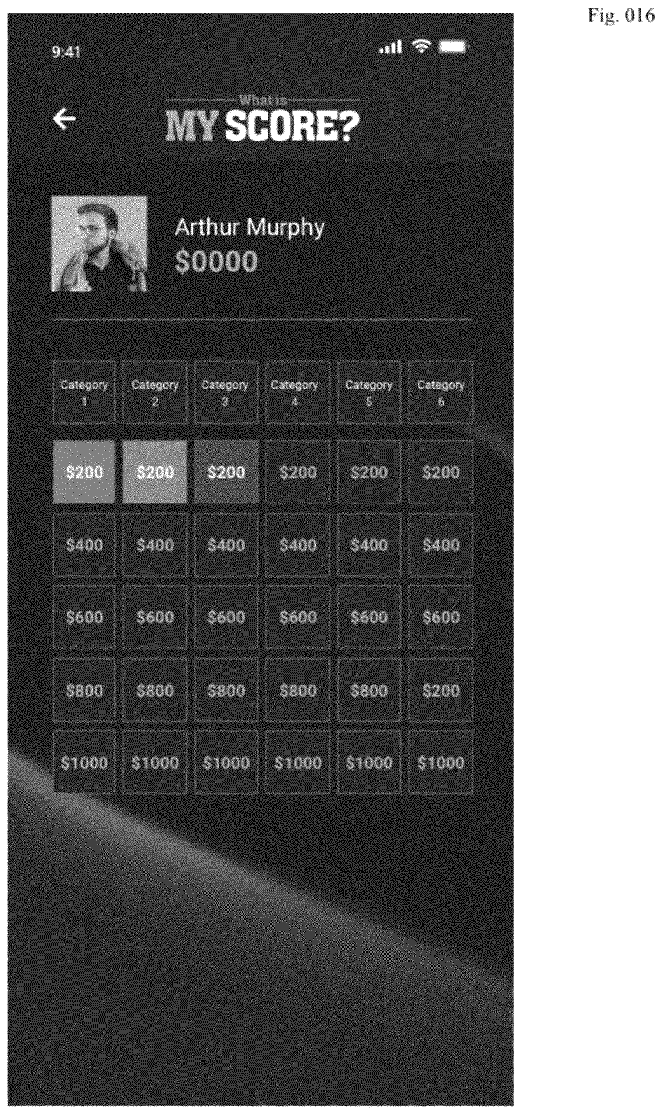

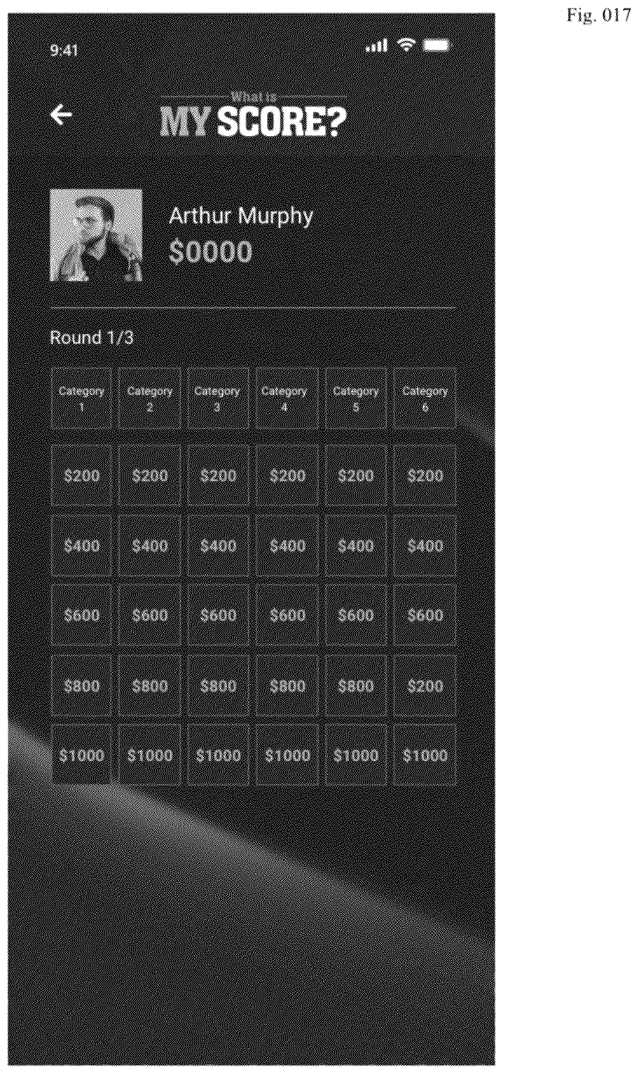

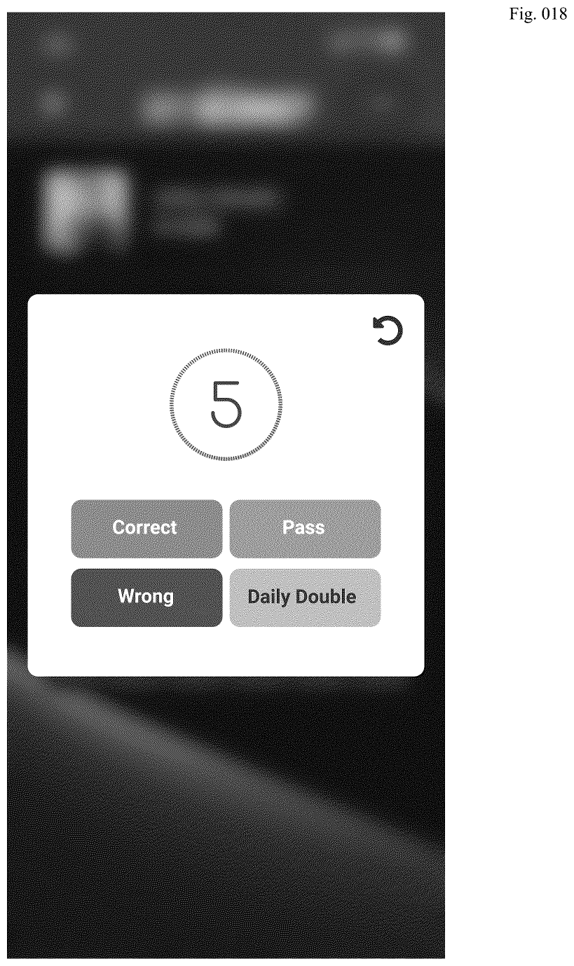

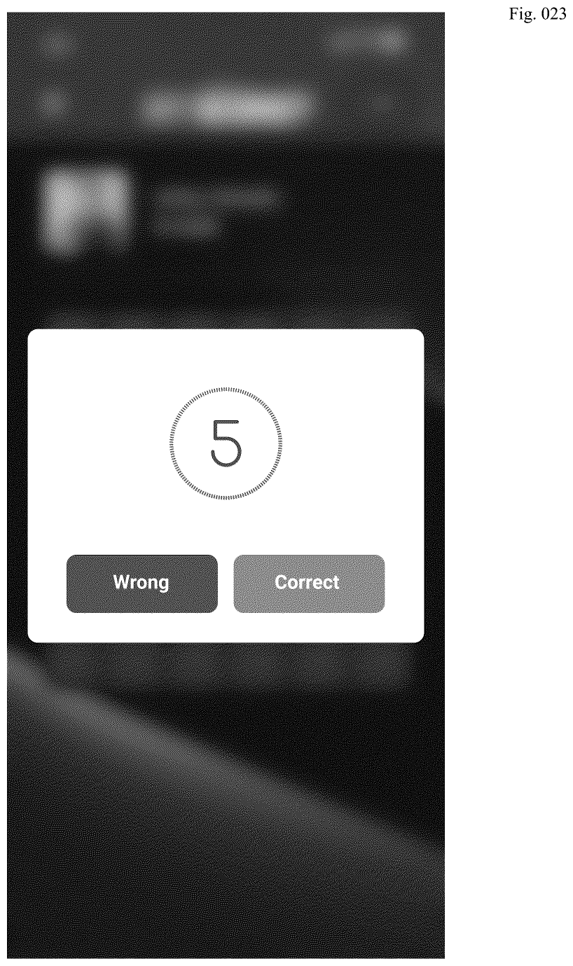

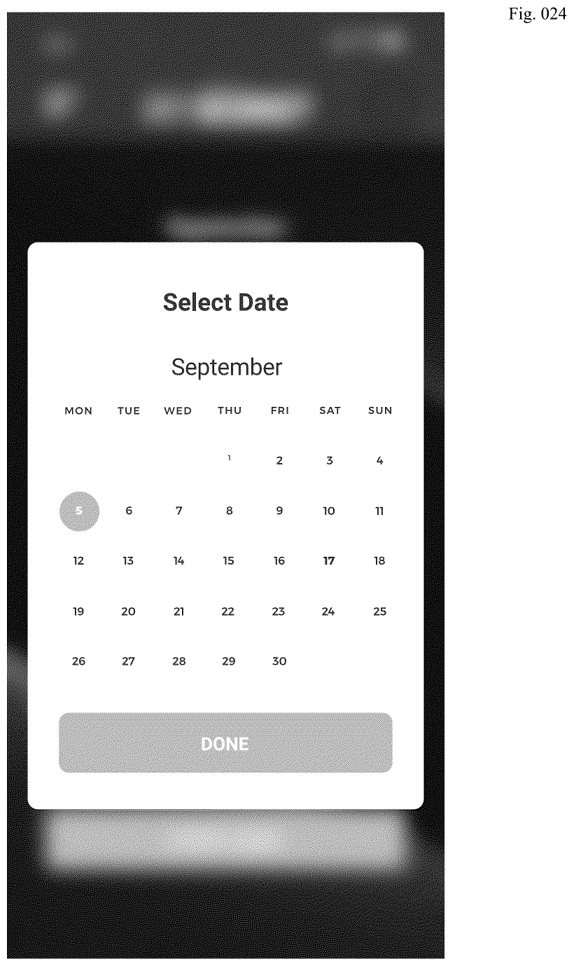

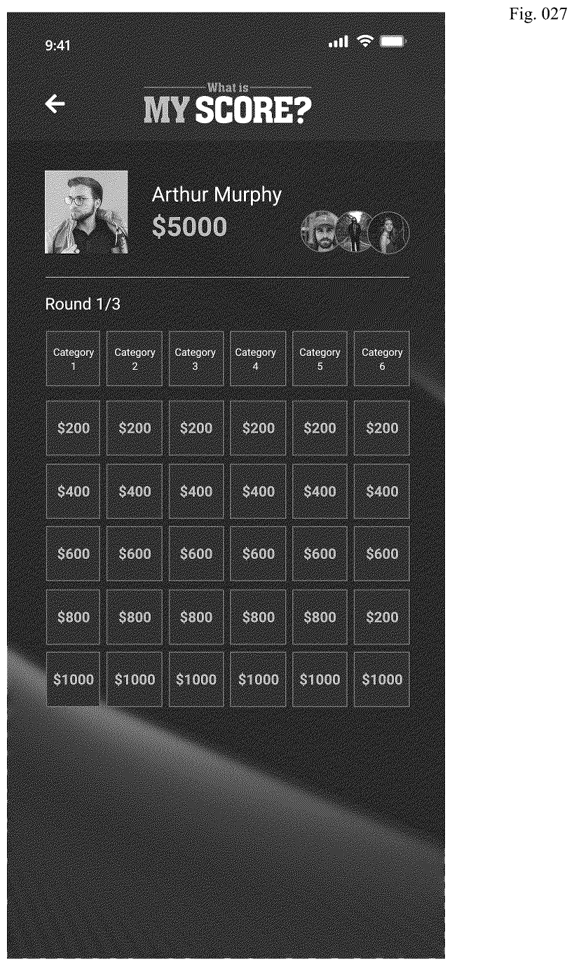

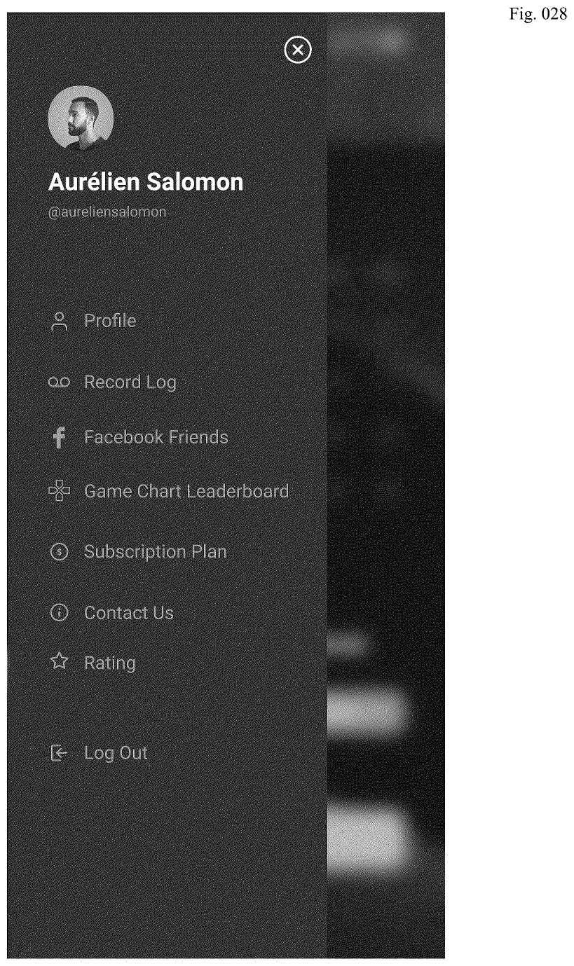

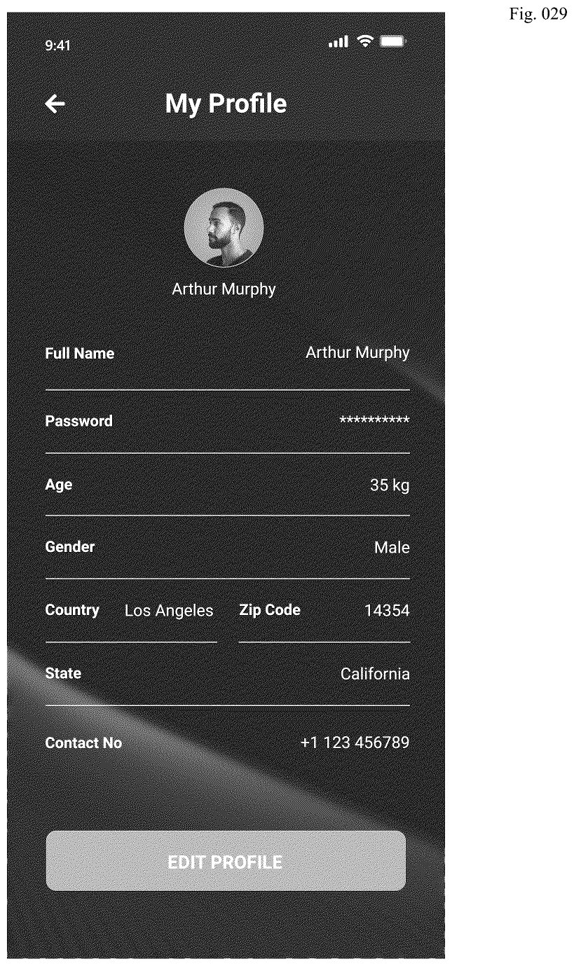

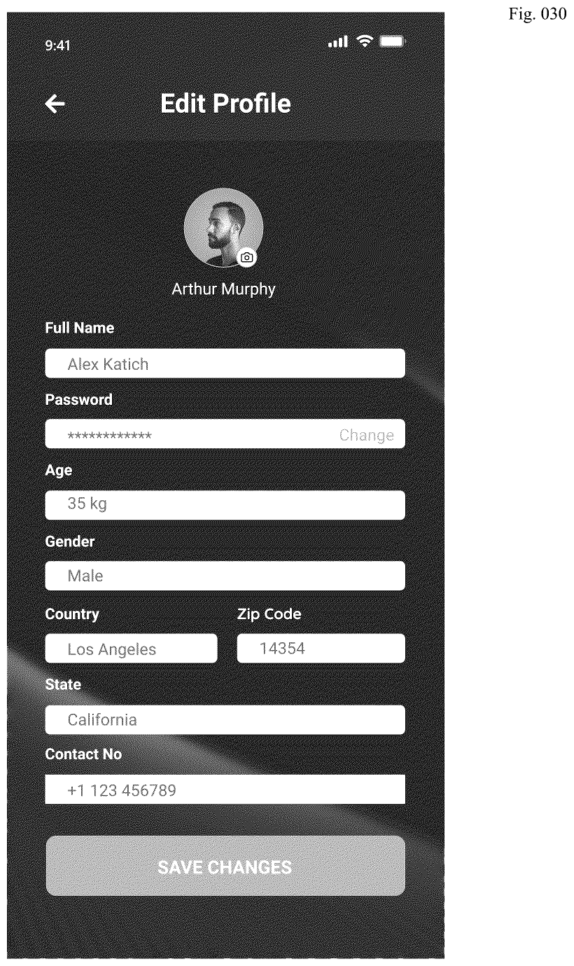

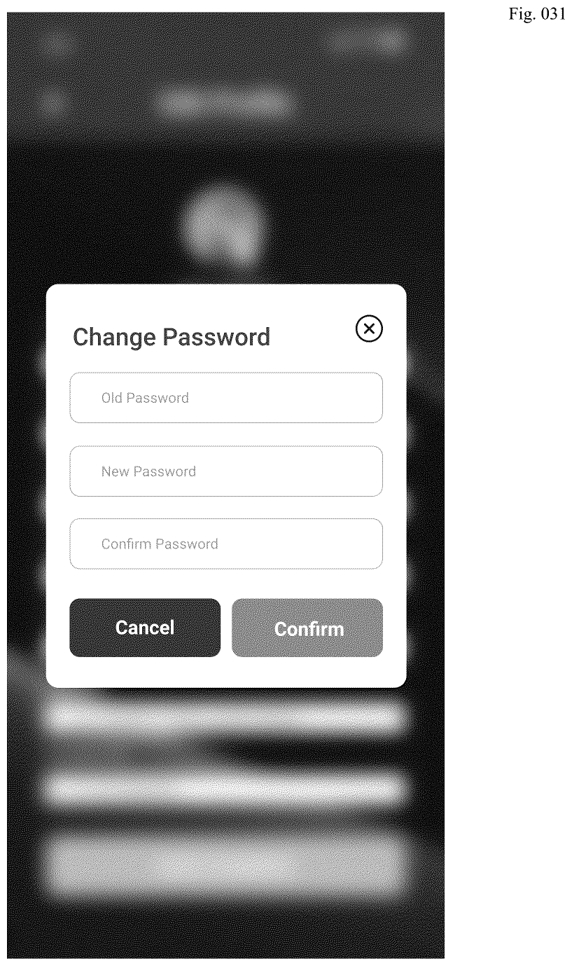

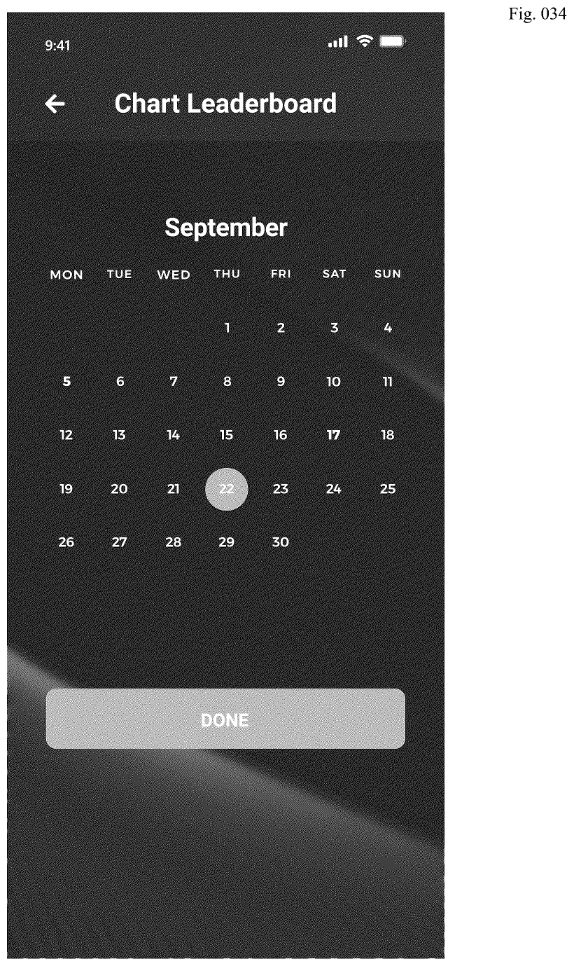

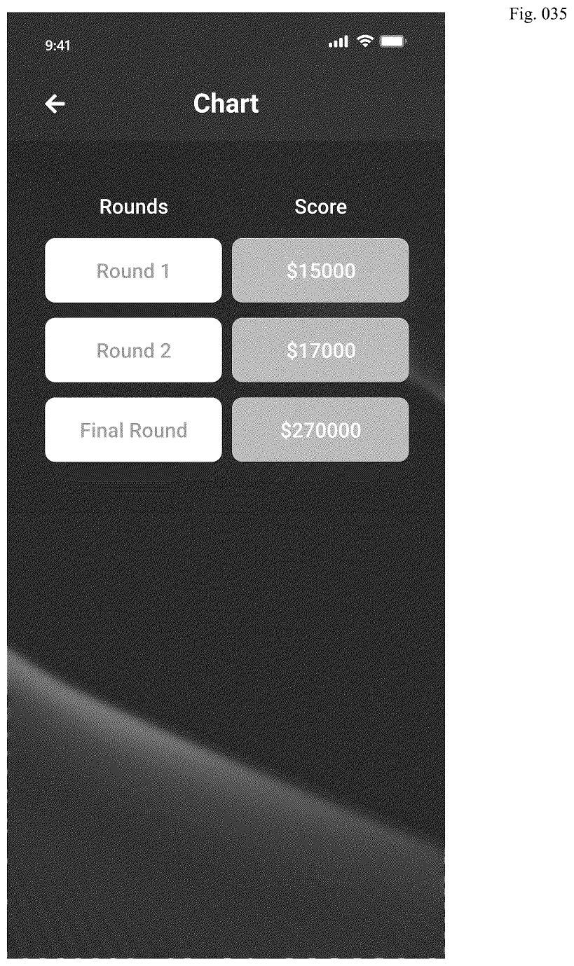

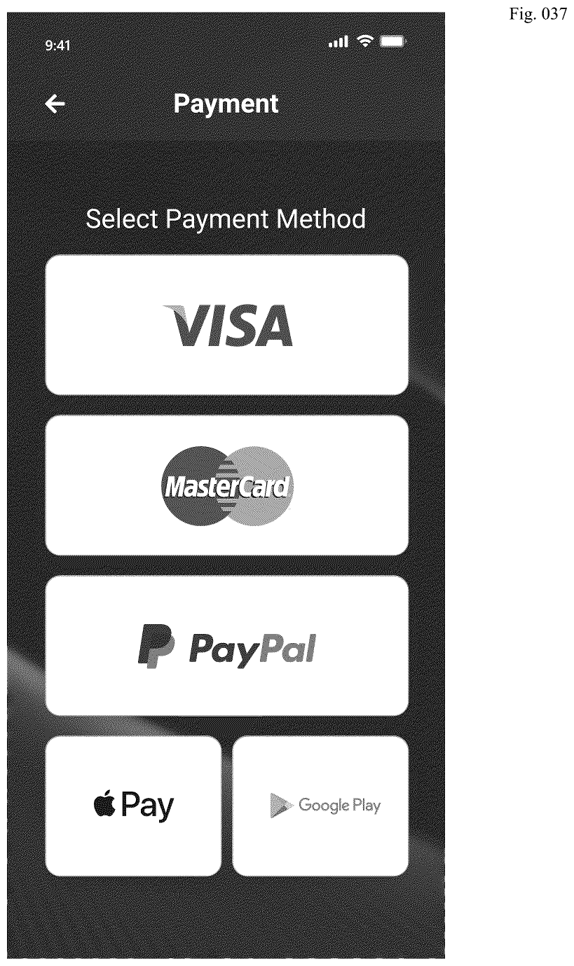

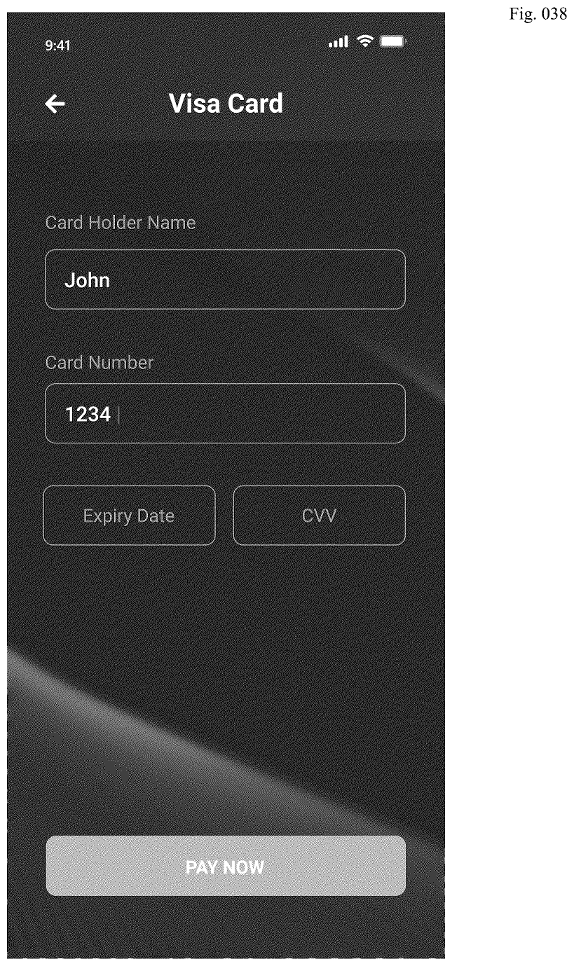

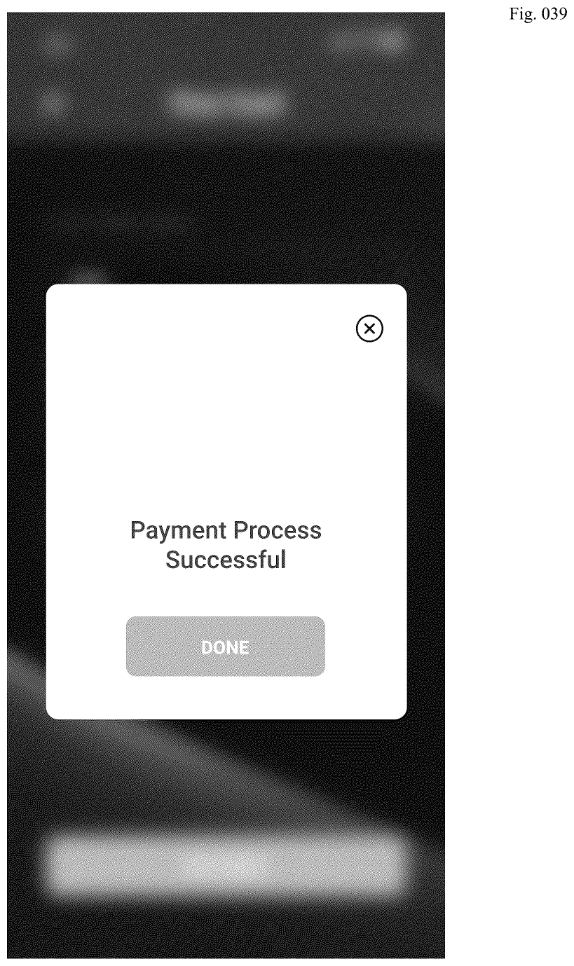

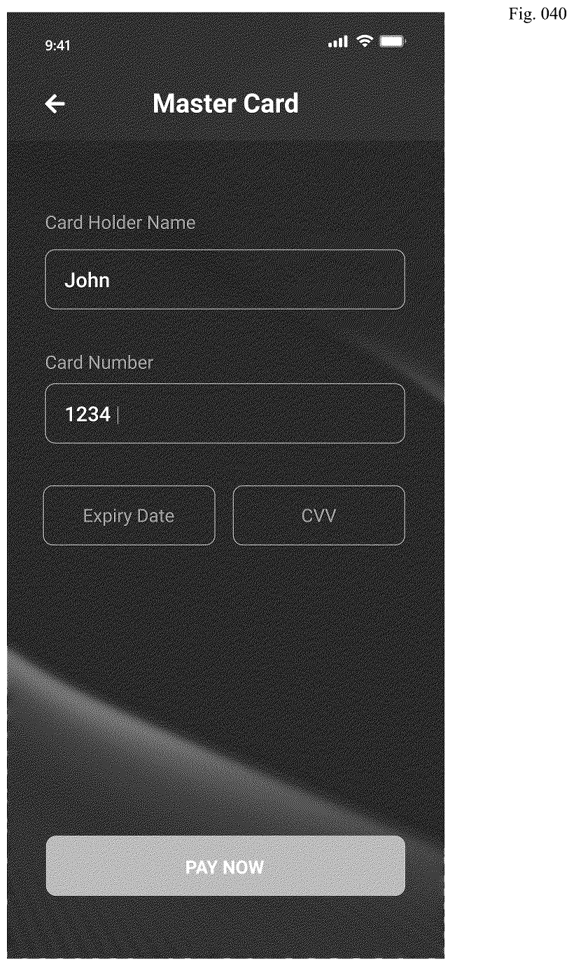

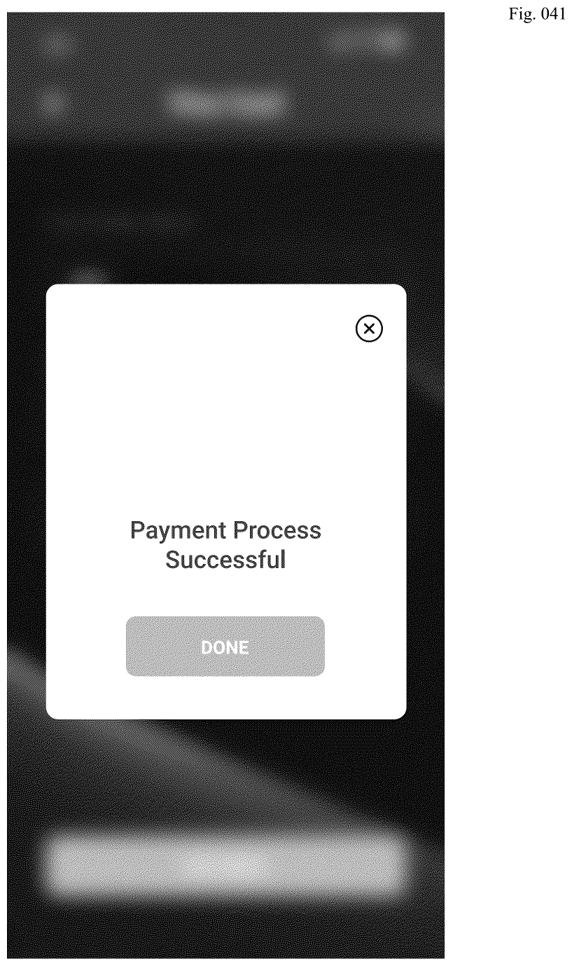

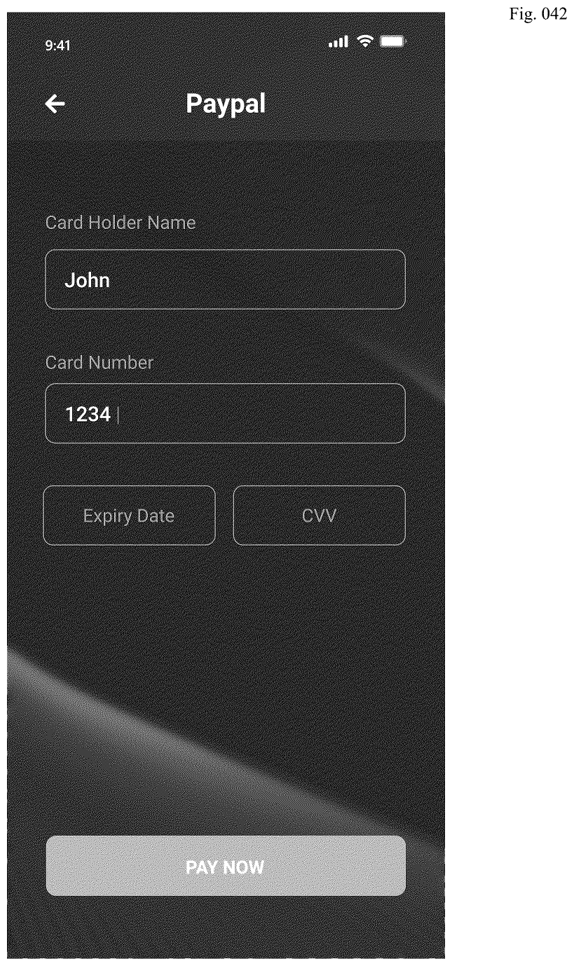

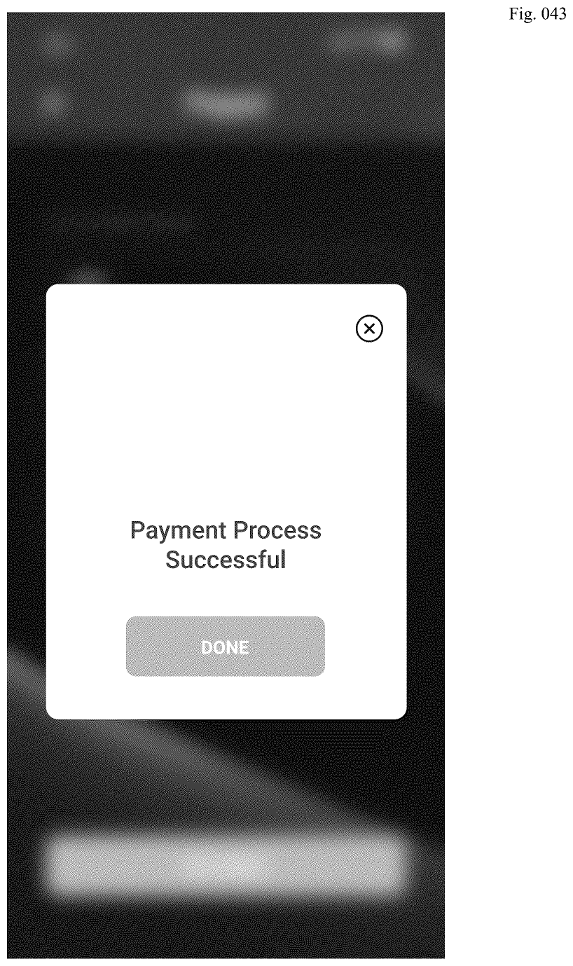

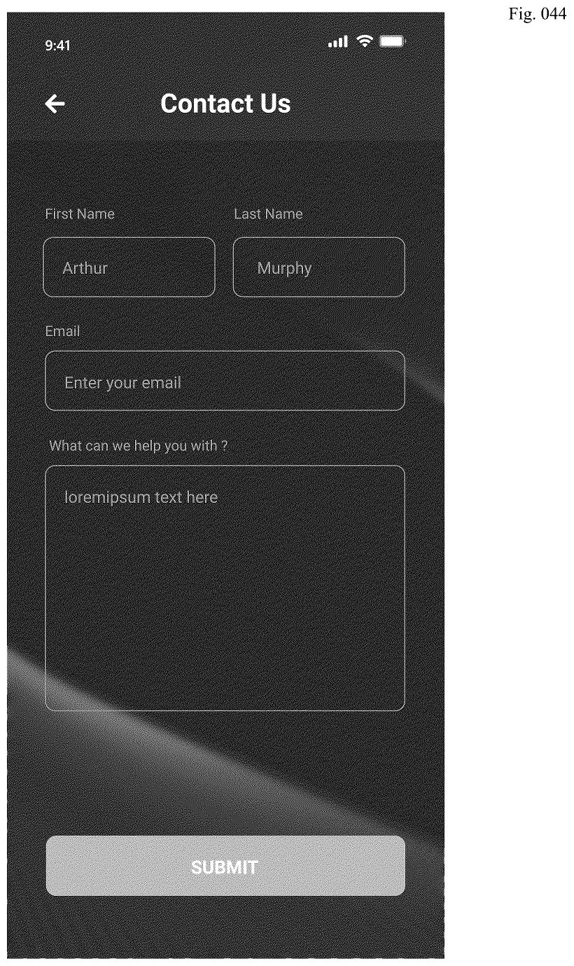

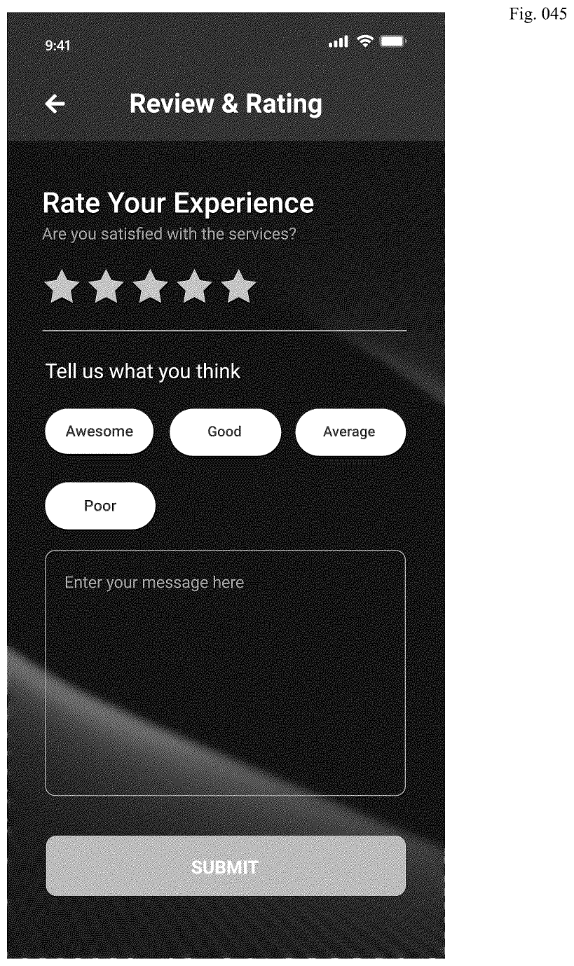

FIGS. 2-45 show various screen shots of the mobile device software application according to one embodiment of the present invention. FIGS. 2-9 show exemplary sign up, password and registration process screen shots.

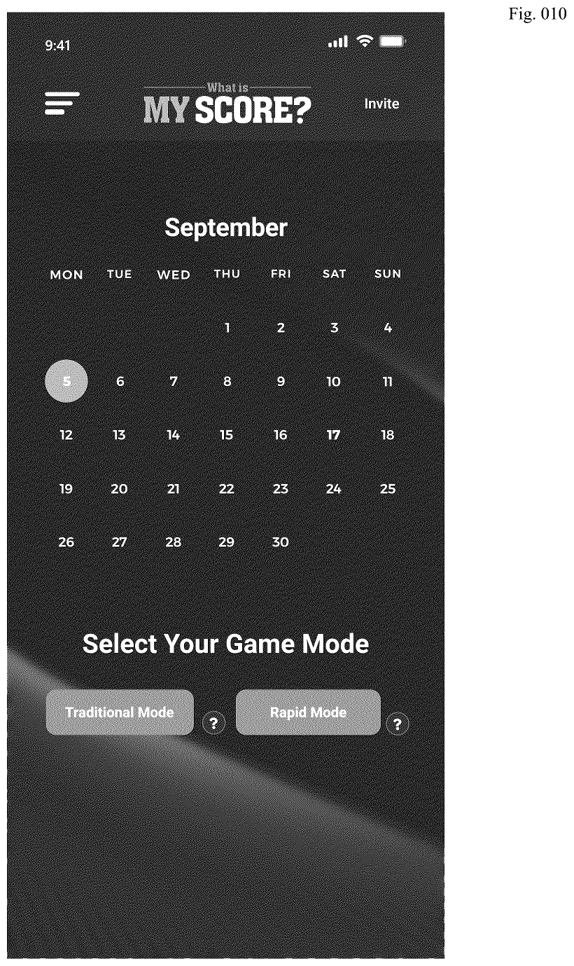

FIG. 10 shows a screen shot with calendar where the player may select the date of a pre-recorded show in which the player desires to play the game with. Once a date and game are selected and completed the player's performance and scored will stored and the date will locked and “greyed” out on the calendar. In this way, the log of games played can be consistent and clean for tournament play against other players. Also, the game mode may be selected from traditional mode or rapid mode.

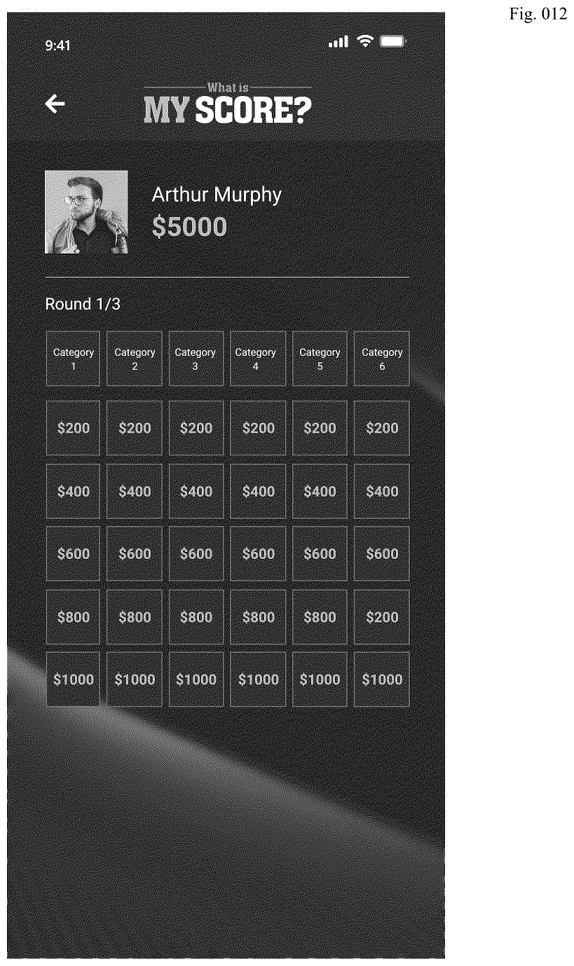

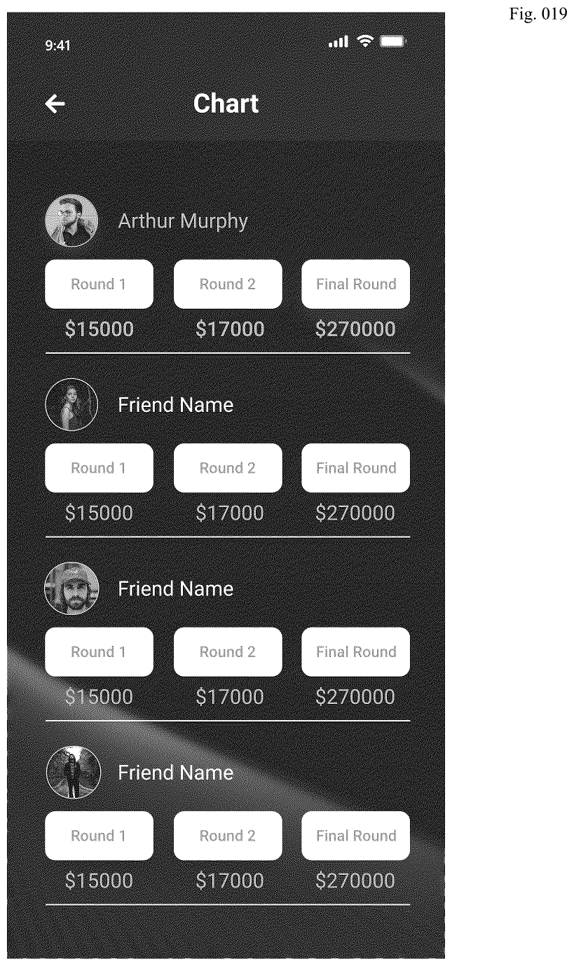

FIGS. 12-19 shows exemplary game play modes in a first round of three having 6 categories and multiple valued boxes for selection by the player to be played simultaneously along with the pre-recorded game or, in other embodiment in self-play mode. FIG. 19 shows a screen shot of a joint game with multiple connect “friends” that can play simultaneously, or in another embodiment, the application can track the progress of each player for the game mode separately.

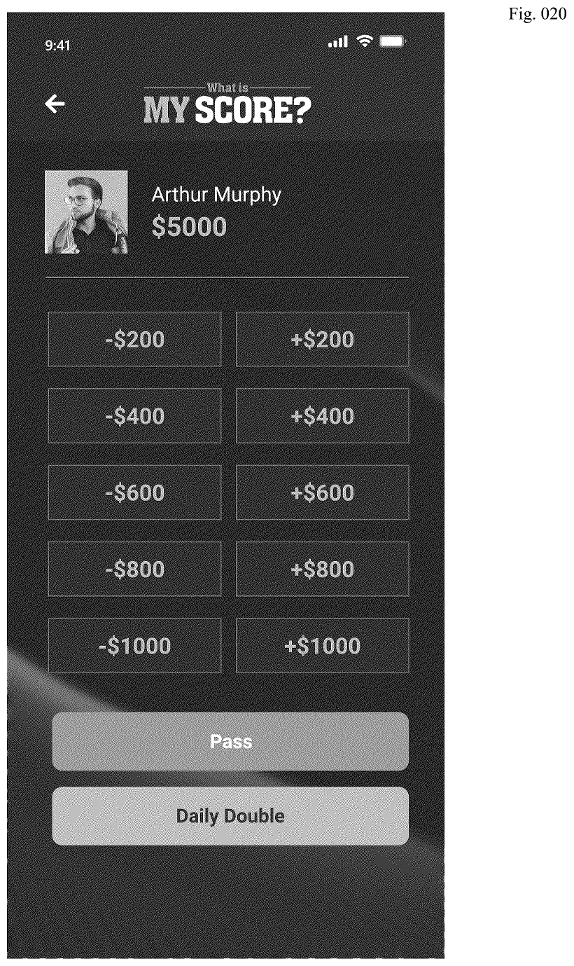

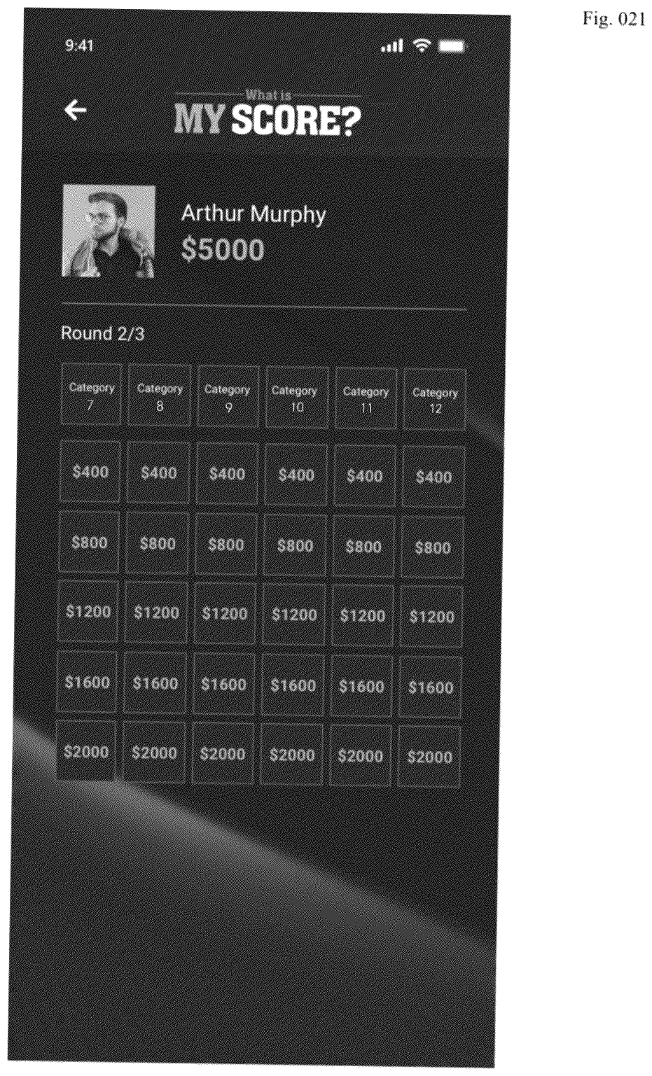

FIG. 20 shows an exemplary screen shot of a daily double higher percentage betting portion of the game play. FIG. 21 shows a second round of three in the game play mode.

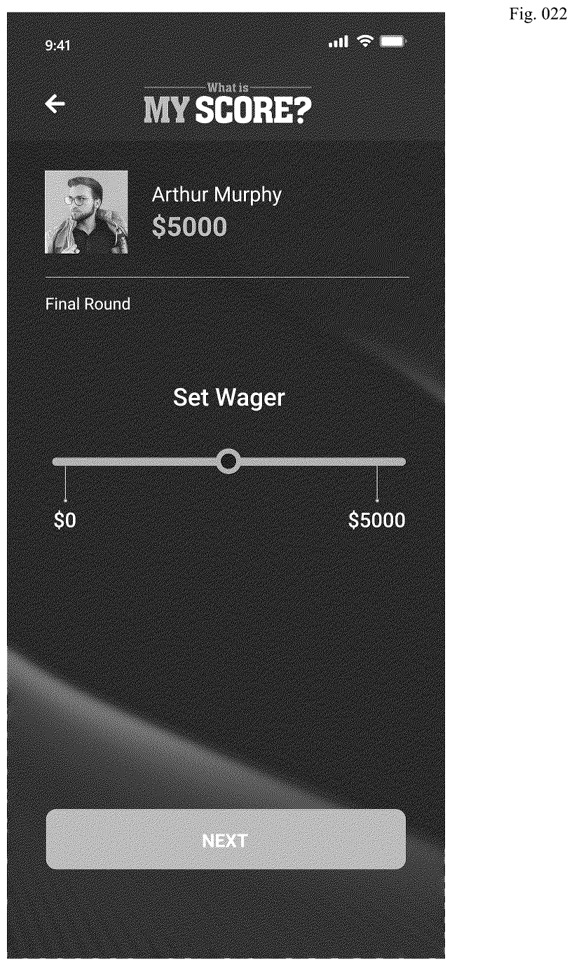

FIG. 22 shows a module where the player can wager actual money on his game play or the gameplay of others. In some embodiments the wagering can be live with in game wagering and odds may change questions to question and answer to answer, as well as with player to player comparisons.

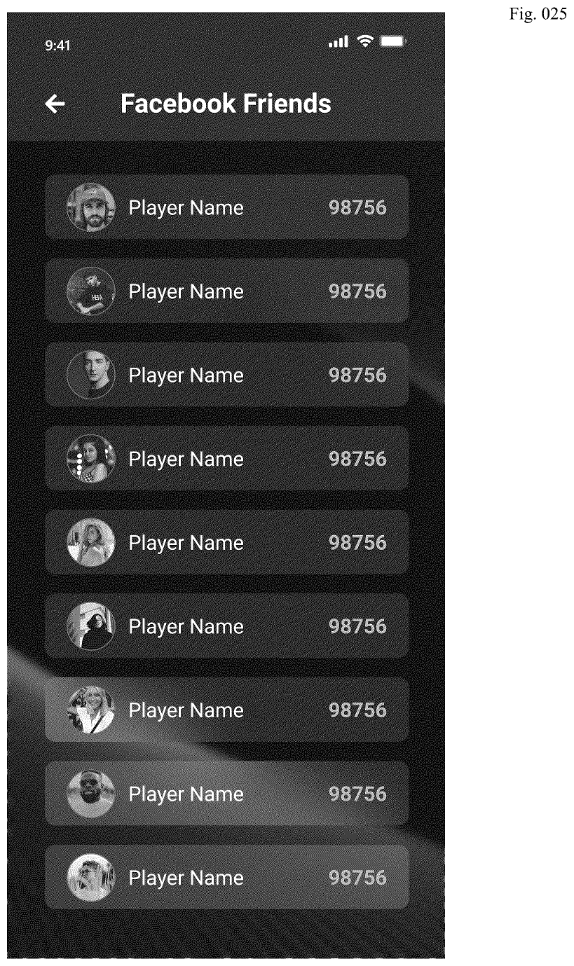

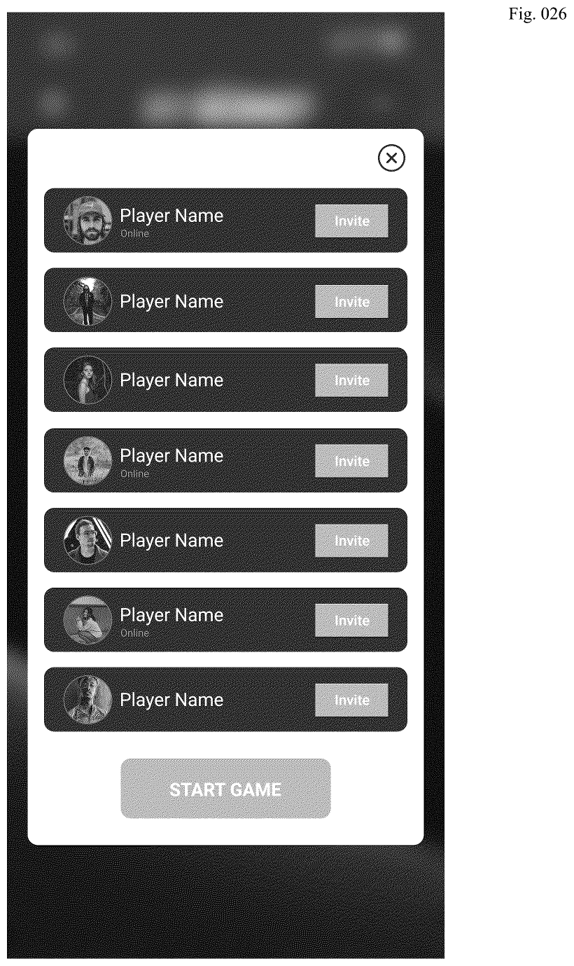

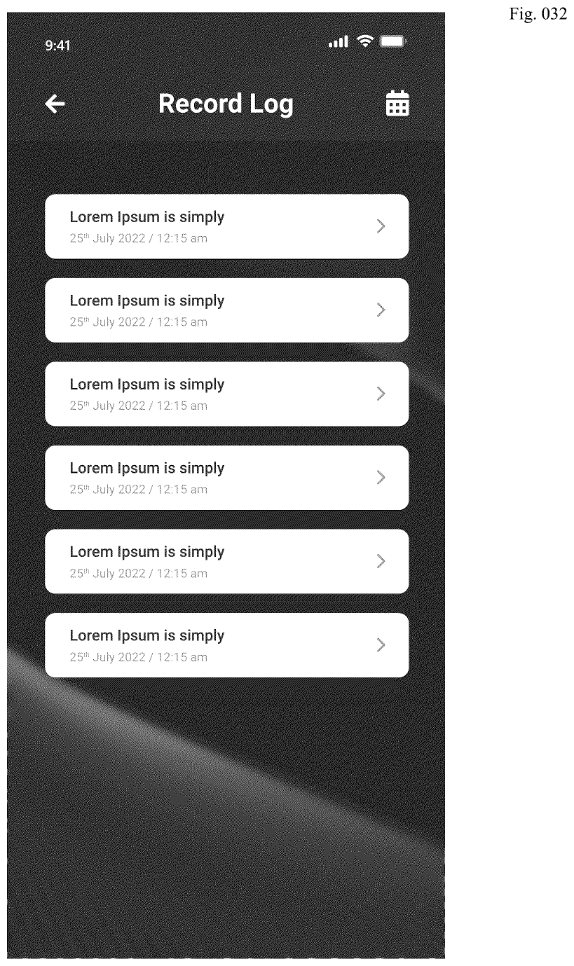

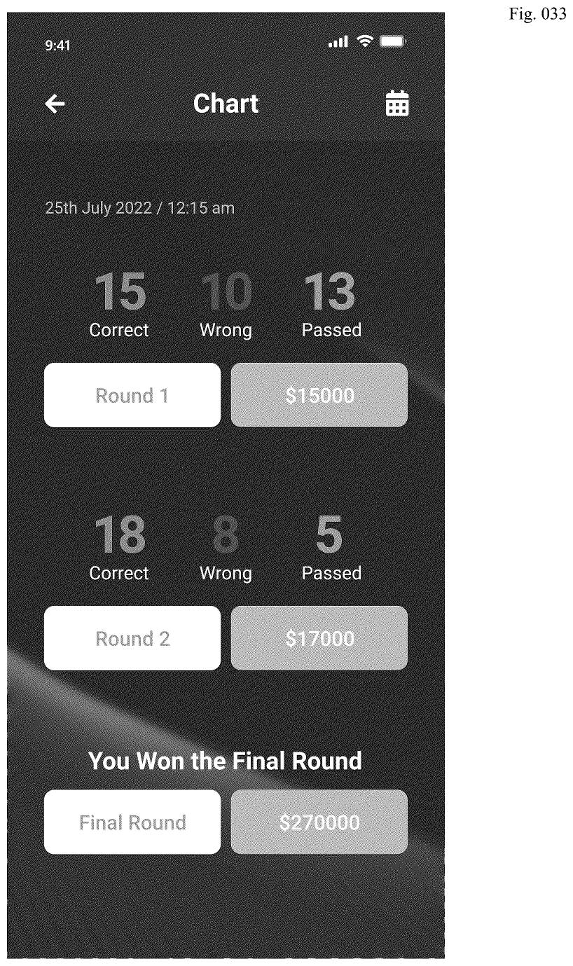

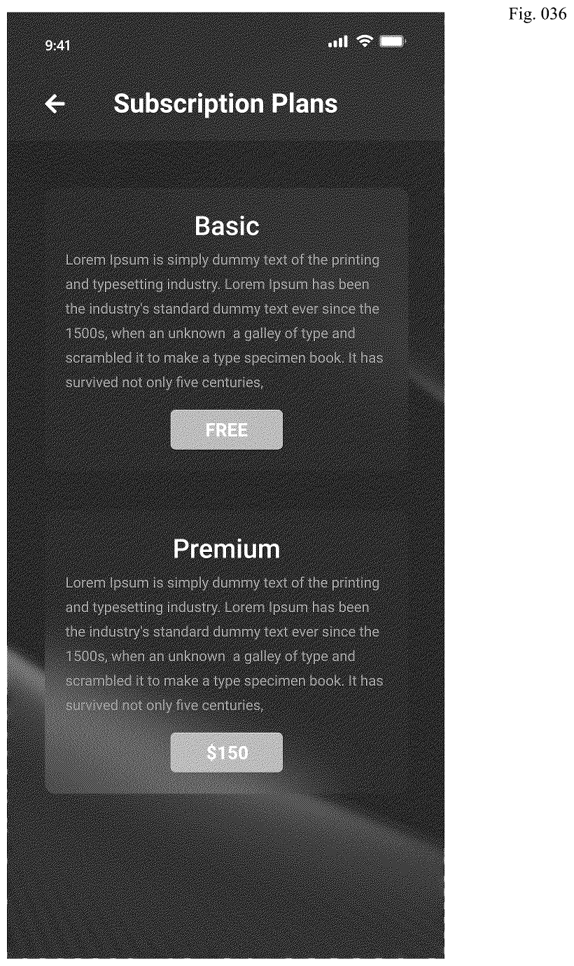

FIGS. 25 and 26 can show a player's other player connections and connections to social media. FIGS. 32 and 33 can show a player's record or log of games played as well as statistics and leader boards. FIGS. 36 through 44 can show subscription, payment and account information.

It will be apparent to one of skill in the art that described herein is a novel apparatus, system and method for a hybrid mobile application for tracking real-time game show scores. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

What is claimed is:

1. A method of playing a game on a web-connected mobile device based on content, comprising:
a player receiving content and one or more game data files, wherein the content is simultaneously viewed by the player as the player plays the game via the internet on the web-connected mobile device;
operating a program on the web-connected mobile device to display one or more dynamic game play screens in phased consistency relative to the simultaneously viewed content; and
the player playing the game by selecting one or more choices related to dynamic game play screens in phased consistency relative to the simultaneously viewed content.

2. The method according to claim 1 further comprising the step of repeating the providing at least two game options to the player.

3. The method according to claim 1 further comprising the step of tracking the player's gameplay and recording said gameplay in a remote database.

4. The method according to claim 3 wherein said gameplay is compared to additional players playing the game.

5. The method according to claim 4 wherein a player is allowed to make a wager before playing the game.

6. The method according to claim 4 wherein a player is required to make a wager while playing the game.

7. The method according to claim 1 wherein said content is based on at least one previously recorded and stored television game show.

8. The method according to claim 1 wherein said content is based on at least one television game show being broadcast simultaneously with the player playing the game.

9. The method according to claim 8 wherein the game data is updated in real time as the player is playing the game.

10. A system for producing and distributing a game on a web connected mobile device based on content, comprising:
a game production device for connecting the content with live game data; and
a first server coupled to the game production device, wherein the server receives and transmits the content and the live game data, wherein the game is played by at least one player selecting one or more choices related to the content.

11. The system according to claim 10 further comprising a second server coupled to the first server for receiving scoring data, determining standings and communicating the standings to the at least one player.

12. The system according to claim 11 wherein the game is played based on content that is selected as one of simultaneously live, on demand and practice.

13. The system according to claim 12 wherein on demand video and game data is simultaneously broadcast to all players at a pre-determined time.

14. The system according to claim 13 wherein the content includes sporting events, game shows, news programming and entertainment shows.

15. The system according to claim 11 further comprising a third server coupled to the first and second server, the third server structured and arranged to mange the at least one player's wagers made before and during the game.
